(19) United States
(12) Patent Application Publication
(10) Pub. No.: US 2015/0267908 A1
(43) Pub. Date: Sep. 24, 2015

(54) INTEGRATION OF LIGHT EMITTING DIODE (LED) OPTICAL REFLECTORS WITH MULTILAYER DIELECTRIC THIN FILM COATING INTO HEAT DISSIPATION PATHS

(71) Applicants: Gabriel Michael Smith, Cleveland, OH (US); Mark J MAYER, Sagamore Hills, OH (US); Koushik SAHA, Brunswick, OH (US); Dengke CAI, Willoughby, OH (US); Matthew Steven MRAKOVICH, Streetsboro, OH (US)

(72) Inventors: Gabriel Michael Smith, Cleveland, OH (US); Mark J MAYER, Sagamore Hills, OH (US); Koushik SAHA, Brunswick, OH (US); Dengke CAI, Willoughby, OH (US); Matthew Steven MRAKOVICH, Streetsboro, OH (US)

(73) Assignee: GE LIGHTING SOLUTIONS, LLC, East Cleveland, OH (US)

(21) Appl. No.: 14/217,658

(22) Filed: Mar. 18, 2014

(51) Int. Cl. F21V 29/70; F21V 29/505; F21V 7/22

(52) U.S. Cl. CPC F21V 29/70; F21V 7/22; F21V 29/505

(57) ABSTRACT

Provided is a lighting assembly including at least one thermally conductive substrate and on multilayered interference dielectric thin film coating. The treated lighting assembly substrate effectively redistributes heat at various vector locations on the optical reflector to cooler vector locations.

### I. FIELD OF THE INVENTION

The present invention relates generally to light fixtures. More particularly, the present invention relates to using dielectric thin film coated thermally conductive light fixture reflectors for cooling the light fixtures.

### II. BACKGROUND OF THE INVENTION

Lighting fixtures include internal light sources, such as light emitting diodes (LEDs). Reflectors generally have locations that are hotter and cooler than the average temperature of the whole reflector. Functionally, these types of lighting fixtures can have limited utility because the max allowable ambient temperature of the fixture is limited by the temperature of hottest spot of any component. For example, this residual heat (i.e., hot spot) can accumulate near the base of the light source, creating an uneven energy distribution across other portions of the light source. Additionally, temperature gradients across that reflector can lead to internal strain that can lead to reflector failures.

In the case of LEDs, particular reflector coatings, such as aluminum or silver, inherently have a unique curve of varying emissivity or absorptivity over different wavelengths. Correspondingly, these reflector coatings have varying degrees of heat absorption/dissipation. Also, these reflector coatings cannot be tuned to display different emissivity or absorptivity characteristics for a particular wavelength of light.

### III. SUMMARY OF EMBODIMENTS OF THE INVENTION

Given the aforementioned deficiencies, a need exists for methods and systems for tuning lighting systems and redistributing the thermal energy over the optical reflectors for the purpose of cooling the optical systems.

In certain circumstances, an embodiment provides at least one optical reflector having a thermally conductive substrate with thermal conductivity greater than 1 w/m*K (watts per meter kelvin), a multilayered interference dielectric thin film coating. The multilayered interference dielectric thin film coating has a reflectance greater than 95% at nominal incident angle.

The illustrious embodiments include thermal conductive substrate for spreading heat across the optical reflector, thus lowering the temperature of the hottest spot of the reflector. In other words, optical reflectors can function as heat sinks. In the embodiments, a thermally conductive optical reflector can be connected to an external heat sink to conduct thermal energy from the optical reflectors to a lower temperature heat sink and ambient air.

In another embodiment, the thermally conductive reflectors are thermally connected to transparent surfaces such as lens, thereby increasing the surface area to dissipate the heat through conduction convection and radiation.

In another embodiment, the thermally conductive optical reflectors have some portions of its surfaces exposed to air that is external to lighting fixtures. This process allows for convective cooling of the system by removing heat directly from the reflector surfaces.

In another embodiment, the multilayer dielectric thin film coating has been tuned though selection of the material of thin film layer and the thicknesses of those thin film layers to create a thin film coating stack on the reflectors that has very high reflectivity in the wavelengths at which that the light source emits, This system will allow for the reflector to reflect a high portion of the visible light produced by the source, thereby preventing the fixture from heating due to absorption of radiant energy. Additionally the reflectors will further cool the fixture by having a relatively high amount of radiant cooling due to the higher emissivity in infrared wavelengths compared to, for example, polished or vapor deposited metals.

In all of these embodiments, reducing the operating temperature of the lighting fixtures increases reliability of thermally sensitive components. This reduction correspondingly increases efficiency of the lighting fixtures, and can increase the maximum ambient temperature rating of the fixtures. Additionally, such reflectors have improved corrosion resistance and can withstand greater operating temperatures and thermal loads.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is an illustration of a light fixture in which embodiments of the present invention can be practiced.

FIG. 2 is an illustration of an exemplary thermally conductive optical reflector having a multilayered optical interference dielectric thin film coating in which embodiments of the present invention can be practiced.

FIG. 3 is an illustration of a thermally conductive optical reflector connected to an external heatsink in accordance with an embodiment of the present invention.

FIG. 4 is an illustration of a thermally conductive optical reflector connected to a second embodiment of the present invention.

FIG. 5 is an illustration of a thermally conductive optical reflector having some portion its surface exposed to air in accordance with a third embodiment of the present invention.

FIG. 6 is an illustration of an exemplary thermally conductive optical reflector that conducts energy from the optical refelctor's hottest spot to a cooler spot in accordance with yet another embodiment of the present invention.

### V. DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

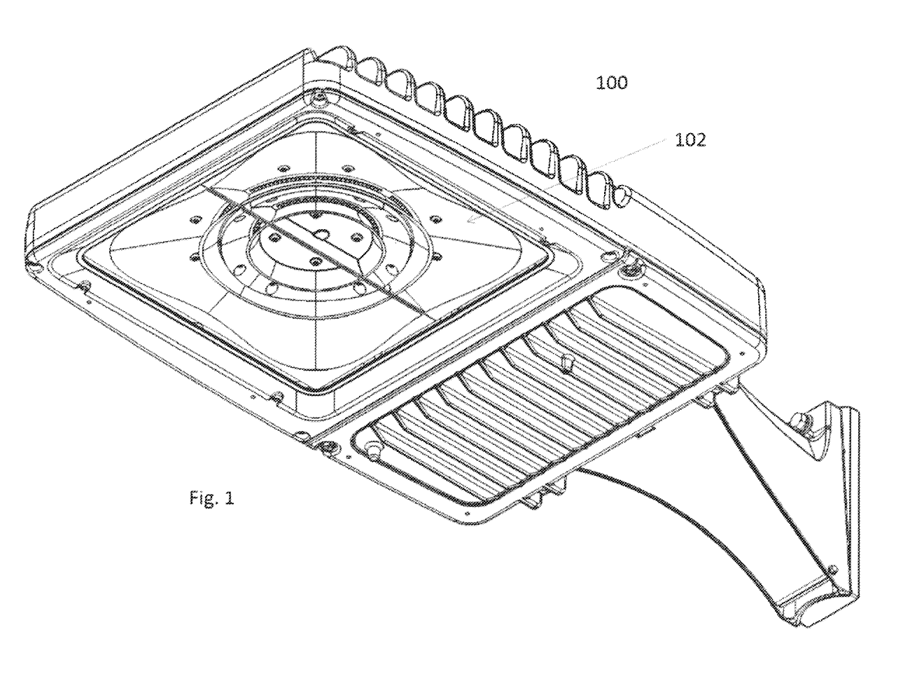

In the embodiments, FIG. 1 is an illustration of an exemplary lighting system 100 in which the embodiments can be practiced. Lighting system 100 includes an optical reflector 102, having a thermally conductive substrate. Disposed on the thermally conductive substrate is a multilayered dielectric thin film coating. The thermally conductive substrate spreads heat across optical reflector 102, effectively lowering the temperature its hottest surface portion. The thermally conductive substrate can be formed, for example, of a metal or ceramic or glass material, or of a composite mixture of such materials.

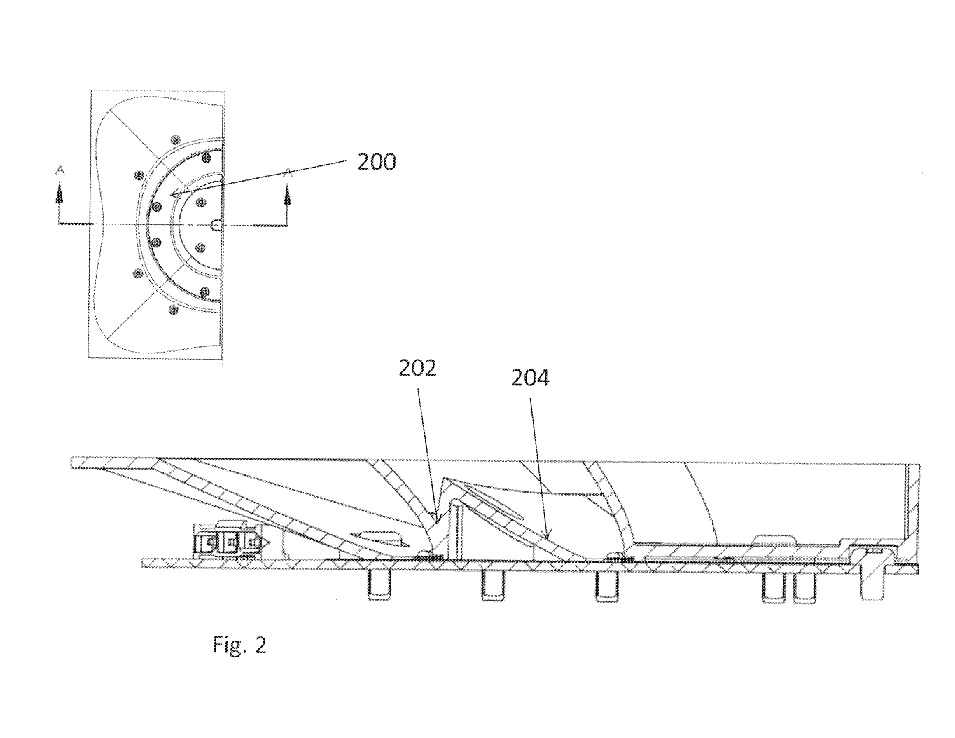

FIG. 2 is an illustration of an exemplary thermal optical reflector 200 of a lighting system constructed in accordance with embodiments of the present invention. The optical reflector 200 includes a thermally conductive substrate 202 and a highly reflective multilayered optical interference dielectric thin film coating 204. The thermally conductive optical reflector 200 can be a mirrored surface having a highly specular reflectance. Further, the multilayered interference dielectric thin film coating 204 is relatively thin in comparison to the thermally conductive substrate 202.

Further, the optical reflector 200 can be reflective with 95% or greater reflectance by use of the multilayered optical interference dielectric thin film coating 204 and the thermally conductive substrate 202. More specifically, 95% or more of photons that strike the surface of multilayered optical interference dielectric thin film coating 204 are reflected resulting in very little radiative heating of the reflective surface. The thermally conductive substrate 202 spreads heat across the optical reflector 200, thereby lowering the temperature of the hottest vector positions thereon.

The multilayer interference dielectric thin film coating 204 typically may include alternating layers of high refractive index and low refractive index materials. High refractive index materials may include titanium dioxide, tantalum pentoxide, niobium pentoxide, zinc sulfide, or similar materials. Low index materials may include silicon dioxide, aluminum oxide, magnesium fluoride and others. All layers in the exemplary multilayer stack are deposited in thicknesses ranging from 0.1 to 400 nanometers. The optical reflector 200 is incident angle and wavelength specific.

The optical reflector 200 typically has a plurality of hot spots in various vector locations. However, since some hot spots are heated unevenly, some optical reflector portions at particular vector locations are hotter, or less hot, than optical reflector portions at other vector locations.

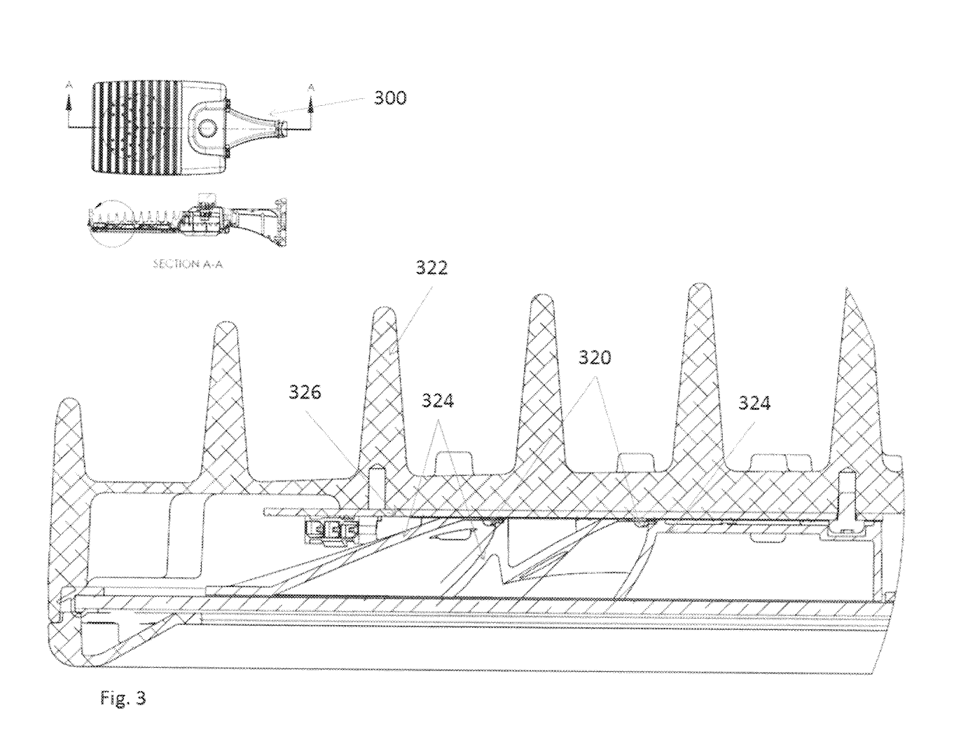

FIG. 3 is an illustration of an exemplary lighting fixture 300 constructed in accordance with the embodiments. The lighting fixture 300 includes a light source 320, an external heat sink 322, and a thermally conductive optical reflector 324.

The optical reflector 324 is thermally connected to the heat sink 322 to conduct thermal energy from the reflector 324 to the heat sink 322. This thermal connection lowers the operating temperature of the optical reflector 324. Interfaces 326 represent thermal conduits between the heat sink 322 and the optical reflector 324. More specifically, a relatively low thermal contact resistance at each of the interfaces 326 facilitates heat transfer from the optical reflector 324 into the heat sink 322.

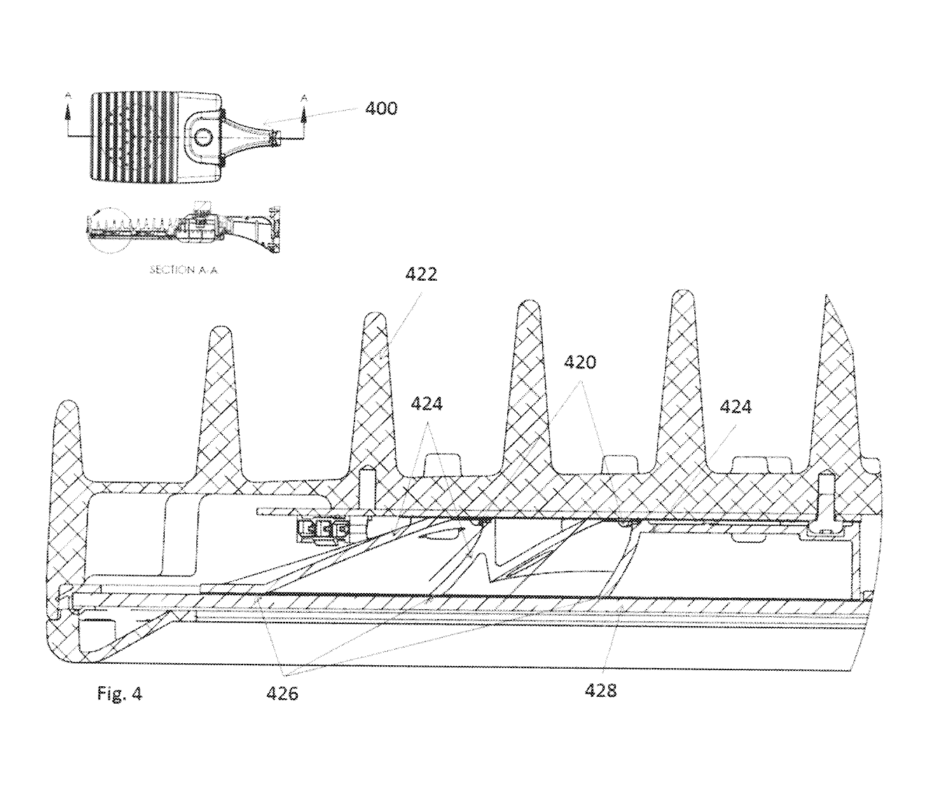

FIG. 4 is an illustration of an exemplary lighting fixture 400 constructed in accordance with a second embodiment of the present invention. The lighting fixture 400 includes a light source 420, a heat sink 422, a thermally conductive optical reflector 424, and a transparent surface such as lens 428.

The optical reflector 424 is connected to the lens 428, thereby increasing the amount of thermal energy leaving the system through the light emitting face of the lighting fixture 400. Interfaces 426 form a thermal conduit between the heat sink 422 and the optical reflector 424. More specifically, a relatively low thermal contact resistance at each of the interfaces 426 conducts heat away from the optical reflector 424 and into the lens 428. The lens 428 can be formed of transparent lens material, such as, polycarbonate (PC), or acrylic, But, by using a transparent lens material such as glass, quartz, sapphire, or yttrium aluminum garnet that have a higher thermal conductivity, as opposed to conventional lens material, the amount of thermal energy transferred can be increased.

As the heat is conducted out of the reflector, the heat spreads over the lens and is exchanged with the air through convection. Thus, if a greater and more even heat distribution were achieved it would result in a more efficient energy transfer from the lens surface.

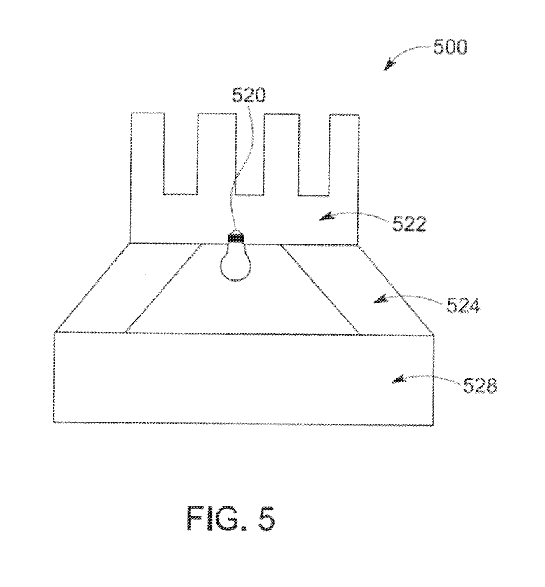

FIG. 5 is an illustration of an exemplary lighting fixture 500 constructed in accordance with a third embodiment of the present invention. The lighting fixture 500 includes a light source 520, a heat sink 522, a thermally conductive optical reflector 524, and a transparent surface such as lens 528. The optical reflector 524 has portions of its surface exposed to air that are external to the lighting fixture 500. This feature enables convective cooling of the system off the optical reflector 524's surface. More specifically, optical reflector 524's surface is exposed to air external to the fixture allowing for convective cooling of the surface.

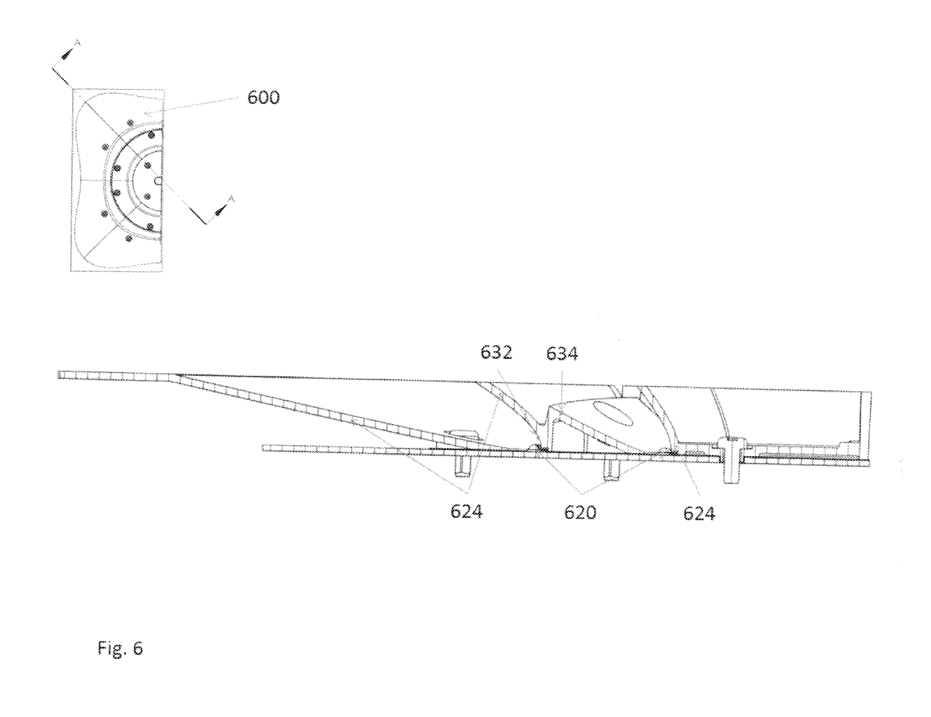

FIG. 6 is an illustration of an exemplary lighting fixture 600 constructed in accordance with other embodiments of the present invention. The lighting fixture 600 includes light sources 620 and thermally conductive optical reflectors 624.

In FIG. 6, the reflector 624 conducts thermal energy from its hottest portions of the optical reflector 624 located at vector locations 632 to a cooler location 634. The hottest portions of the optical reflectors 624, located at vector locations 632, generally radiate energy to another optical surface within the fixture. This additional optical surface of the optical reflectors 624 will be cooler at various vector locations 634. The cooler points 634 are typically more remote and radiate energy to outside the lighting assembly 600. Therefore using a thermal conductive reflector the temperature of location 634 can be raised and the temperature at location 632 can be lowered resulting in a reflector that more efficiently cools the system through radiation.

### CONCLUSION

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. An lighting system comprising:
an optical reflector having a thermally conductive substrate, thermal conductivity greater than 1 watts per meter kelvin (W/m*K); and
a multilayered interference dielectric thin film coating disposed on the thermally conductive substrate;
wherein the multilayer interference dielectric thin film coating increases a reflectivity of the thermally conductive substrate with a reflectance greater than 95% at nominal incident angle.

2. The lighting assembly according to claim 1, wherein said thermally conductive substrate spreads heat across the optical reflector and therefore lowers the temperature of a hottest spot of said optical reflector wherein excess heat is absorbed.

3. The lighting assembly according to claim 1, wherein said thermally conductive reflector is thermally connected to a heat sink to conduct thermal energy from said optical reflector to a lower temperature heat sink.

4. The lighting assembly according to claim 1, wherein the thermally conductive reflectors are thermally connected to transparent surfaces thereby increasing an amount of thermal energy leaving the lighting assembly through a light emitting face of the lighting assembly.

5. The lighting assembly according to claim 4, wherein the transparent surfaces are designed from a thermally conductive material that would further increase an amount of thermal energy leaving the system through faces of the transparent surfaces.

6. The lighting assembly according to claim 1, wherein the thermally conductive optical reflectors have some surface portions exposed to air that is external to the lighting assembly allowing for convective cooling of the optical reflector surfaces

7. The lighting assembly according to claim 1, wherein a multilayered interference dielectric thin film coating minimizes absorbance and transmission to the reflector surface in the visible wavelengths produced by the lighting system thereby increasing reflected radiation out of the lighting assembly; and having higher emissivity in the infrared wavelengths, thereby increasing amount of thermal energy leaving said lighting assembly through radiation.

8. An lighting system method, comprising:
providing an optical reflector having a thermally conductive substrate, thermal conductivity greater than 1 watts per meter kelvin (W/m*K); and
providing a multilayered interference dielectric thin film coating disposed on said thermally conductive substrate;
wherein said thermally conductive substrate is highly specular reflective with 95% or greater reflectivity by use of said multilayer interference dielectric thin film coating.

9. The method of claim 8, wherein said thermally conductive substrate spreads heat across the optical reflector and therefor lowers the temperature of a hottest spot of said optical reflector wherein excess heat is absorbed.

10. The method of claim 8, wherein said thermally conductive reflector is thermally connected to a heat sink to conduct thermal energy from said optical reflector to lower a temperature heat sink.

11. The method of claim 8, wherein the thermally conductive reflectors are thermally connected to transparent surfaces thereby increasing an amount of thermal energy leaving the lighting assembly through a light emitting face of the lighting assembly.

12. The method of claim 11, wherein the transparent surfaces are designed from a thermally conductive material that would further increase an amount of thermal energy leaving the system through faces of the transparent surfaces.

13. The method of claim 8, wherein the thermally conductive optical reflectors have some surface portions exposed to air that is external to the lighting assembly allowing for convective cooling of the optical reflector surfaces of the lighting assembly.

14. The method of claim 1, wherein thermally conductive optical reflectors conduct thermal energy from hottest optical reflector points and wherein the thermally conductive optical reflectors tend to radiate to other optical surfaces, to cooling point, that tend to be more remote and radiate to outside the lighting assembly.

15. The method of claim 8, wherein radiation to out of lighting assembly with the multilayered interference dielectric thin film coating minimizes absorbance and transmission to the reflector surface in the visible wavelengths produced by the lighting system thereby increasing reflected radiation out of the lighting assembly; and having higher emissivity in the infrared wavelengths, thereby increasing amount of thermal energy leaving said lighting assembly through radiation.

16. The method of claim 15, wherein the optical reflectors remain cool by reflecting most of wavelength radiant energy having radiation from other abundant sources.

17. The method of claim 16, wherein increasing cooling by radiating relatively high amounts of wavelength radiation energy to various optical reflector vector locations results in wavelength radiation energy from other lighting sources being low.
